(19) United States
(12) Patent Application Publication
(10) Pub. No.: US 2006/0226952 A1
(43) Pub. Date: Oct. 12, 2006

(54) LF channel switching

(75) Inventors: Josef Baumgartner, Voels (AT); Gerald Ostrander, Davison, MI (US); Patricia Kachouh, Sterling Heights, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/363,308

(22) Filed: Feb. 27, 2006

Related U.S. Application Data
(60) Provisional application No. 60/669,782, filed on Apr. 8, 2005.

(51) Int. Cl. G05B 19/00

(52) U.S. Cl. 340/5.61; 340/5.72; 455/277.1

(57) ABSTRACT

A passive start and entry system utilizes a receiver/transmitter to communicate with a remote actuation device through low frequency radio signals. The remote actuation device includes a plurality of signal receiving coils. A signal strength received by each of the plurality of coils is measured to determine a direction of a desired signal and undesired signals. The signal receiving coil receiving a signal in a direction determined to correspond to the unwanted signal is switched off to eliminate potential interfering signals from disrupting communication with the receiver/transmitter of the passive start and entry system.

### CROSS REFERENCE TO RELATED APPLICATION

The application claims priority to U.S. Provisional Application No. 60/669,782 which was filed on Mar. 8, 2005.

### BACKGROUND OF THE INVENTION

This invention generally relates to a method of operating a remote keyless entry system. More particularly, this invention relates to a method of selectively switching off coils of a key fob to improve signal reception.

A remote keyless entry system includes a receiver transmitter disposed within a vehicle that communicates with a key fob located remotely from the vehicle. The key fob includes several coils to receive signals from the receiver transmitter. The strength of the signal is best when received parallel to a magnetic field vector for the coils. Accordingly, the key fob includes a 3-dimensional coil to provide maximum reception regardless of the orientation of the key fob relative to the incoming signal. Signals received from each axis of the coil are then summed, demodulated and decoded.

Disadvantageously, the 3-dimensional coil also can pick up unwanted interfering signals that do not originate from the receiver/transmitter within the vehicle. The unwanted interfering signals are also summed with the desired signals. The unwanted signals can interfere with the desired wanted signals to such a magnitude that it can prevent the desired signals from being accurately received.

Accordingly, there is a need to develop a method of preventing unwanted signals from disrupting and preventing accurate receipt of desired signals between a vehicle transmitter and a key fob.

### SUMMARY OF THE INVENTION

An example key fob for a passive entry system operates to switch off the coil receiving the greatest undesirable signal to provide for the uninterrupted reception of desired signals.

An example passive start and entry system according to this invention utilizes a receiver/transmitter to communicate with a remote key fob through low frequency radio signals. Many low frequency signals are emitted by other electronic device, such as for example other vehicles. Proliferation of electronic devices is increasing and produces many unwanted signals that are received by the key fob. The unwanted signals can in some instances by of such strength as to overwhelm the desired signals and render communication between the key fob and the receiver/transmitter inoperative. The inventive method described by way of example in this disclosure address this problem and provides for substantially uninterrupted communication with the PASE system.

An example method according to this invention includes the initial step of receiving multiple low frequency signals with the key fob. Once the signal is received, by each of a plurality of coils, the strength of each received signal is measured to determine the direction of the desired signal and the direction of an undesired or unwanted signal. The direction of the unwanted signal is determined as the greatest signal strength determined to originate in a direction other than the direction of the desired signal. Once this direction is determined, the coil disposed to receive signals in the direction determined to correspond to the unwanted signal is switched off. With the coil determined to be receiving the greatest signal strength of undesired signals switched off, the remaining signals are summed by the controller to provide a resultant signal utilized to establish communications, provide instructions and synchronize the receiver/transmitter with the key fob.

Accordingly, the example method of operating a key fob disclosed provides for the uninterrupted communication between a receiver/transmitter disposed within a vehicle and a key fob by eliminating interfering signals that may be present.

These and other features of the present invention can be best understood from the following specification and drawings, the following of which is a brief description.

### BRIEF DESCRIPTION OF THE DRAWINGS

FIG. 1 is schematic view of a vehicle including example passive start and entry system according to this invention.

FIG. 2 is a schematic view of an example key fob according to this invention.

FIG. 3 is a block diagram illustrating an example method according to this invention.

### DETAILED DESCRIPTION OF THE PREFERRED EMBODIMENT

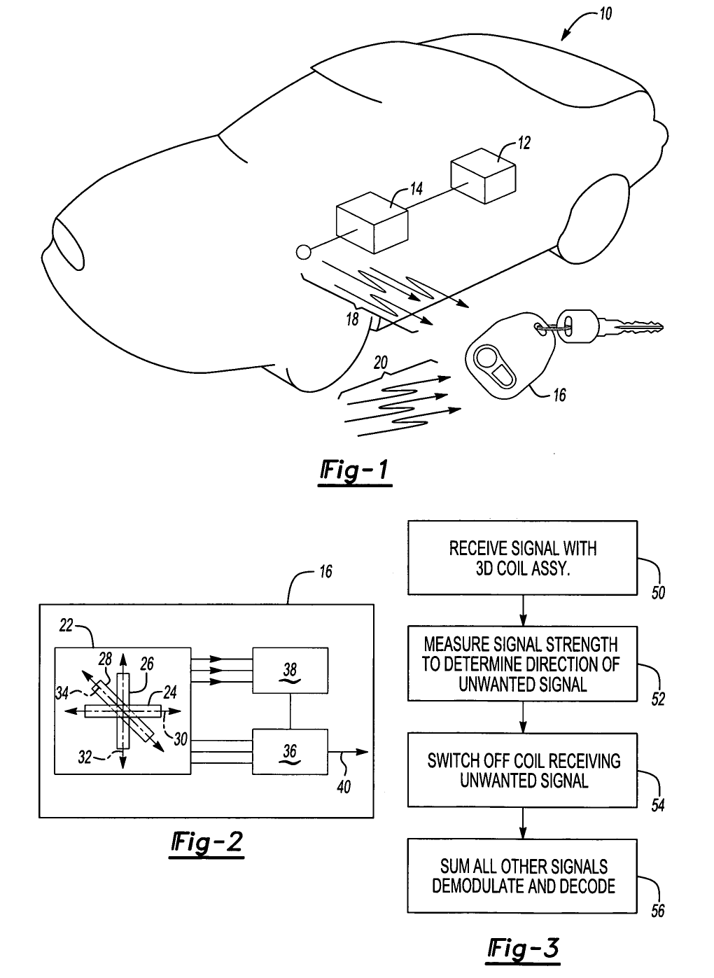

Referring to FIG. 1, a vehicle 10 includes a passive start and entry system (PASE) schematically indicated at 12 that utilizes a receiver/transmitter 14 to communicate with a remote key fob 16. The key fob 16 communicates with the receiver/transmitter 14 through low frequency radio signals. The key fob 16 receives a desired signal 18 from the receiver/transceiver 14 that is demodulated and decoded to assure proper operation. Further, the receiver/transmitter 14 emits the signal 18 to assure synchronization between the key fob 16 and the various operating system actuated responsive to operation of the key fob 16.

As appreciated, many low frequency signals are emitted by other electronic devices, such as for example other vehicles. Proliferation of electronic devices is increasing and produces many unwanted signals, as are schematically indicated at 20 that are received by the key fob 16. The unwanted signals 20 can in some instances by of such strength as to overwhelm the desired signals 18 and render communication between the key fob 16 and the receiver/transmitter 14 inoperative. The inventive method described by way of example in this disclosure addresses this problem and provides for substantially uninterrupted communication with the PASE system 12.

Referring to FIG. 2, the key fob 16 is schematically illustrated and includes a 3-dimensional coil assembly 22. Signal received by the signal receiving coils are strongest when received parallel to an axis of a corresponding magnetic field. Accordingly, the 3-dimensional coil assembly 22 includes a plurality of coil assemblies disposed along differing axes to maximize reception for any orientation of the key fob 16. The 3-dimensional coil assembly 22 includes a first coil 24 disposed along a first axis 30, a second coil 26 disposed along a second axis 32, and a third coil 28 disposed along a third axis 34. Each of the axes 30, 32, and 34 are transverse to each of the other axes. The configuration of the signal receiving coils 24, 26, and 28 are as know to a worker skilled in the art. Further, other multiple coil assembly receivers as are know to a worker skilled in the art would also benefit from the disclosure of this invention. Additionally, other signal receiving devices such as antennas, are also within the contemplation of this invention.

Each of the coils 24, 26 and 28 receive best or maximum signal strength parallel to the magnetic axis. Accordingly, depending on the direction of the desired signal 18, the received signal strength for each of the coils 24, 26, and 28 will be different, with one of the coils 24, 26, 28 having a greatest signal strength, and one having a weakest signal strength. In most instances, the greatest signal strength is a result of receiving not only the desired signal 18, but also the undesired signal 20 emitted from another source. The key fob 16 includes a received signal strength indicator (RSSI) 38 that measures the incoming signal strength. According to the method of this invention, the coil 24, 26, 28 with the greatest signal strength in a direction other than the direction of the desired signal is switched off. The remaining signals from the remaining coils is relayed to a controller 36 for summing to provide a resultant signal 40 utilized for communicating and synchronizing the key fob 16 with the receiver/transmitter 14.

Referring to FIG. 3, the method according to this invention includes the initial step of receiving multiple low frequency signals with the key fob 16 as is indicated at 50. As appreciated, for instances when only the desired signal 18 is received it is not necessary to determine which single to utilize. However, this method will operate with only the desired signal as only the coil with the greatest signal strength coming from a direction other than the direction of the desired signal 18 is switched off. In such an instance, the received signal strength from the second most directly aligned coil would be eliminated, but as other signals are still available for summing, such a cancellation would not adversely affect communication.

Once the signal is received, by each of the coils 24,26,28, the strength of each received signal is measured as is indicated at 52 to determine the direction of the desired signal 18 and the direction of the undesired or unwanted signal 20. The direction of the unwanted signal is determined as the greatest signal strength determined to originate in a direction other than the direction of the desired signal 18. Once this direction is determined, the coil disposed to receive signals in the direction determined to correspond to the unwanted signal is switched off as is indicated at 54. As appreciated, switched off refers to both the physical disconnection of that coil or to the simply disregard or non use of any signal from that coil for the purposes of establishing communications with the receiver/transmitter 14.

Once the coil determined to be receiving the greatest signal strength of undesired signals has been switched off or disregarded, the remaining signals are summed by the controller 36, as is indicated at 56, to provide a resultant signal 40 utilized to establish communications, provide instructions and synchronize the receiver/transmitter 14 with the key fob 16. This process is repeated at regularly determined intervals such that the signal strength is essentially continually reviewed to switch coils on and off to provide the desired non-interrupted communication between the receiver/transmitter 14 and the key fob 16.

Accordingly, the example method of operating a key fob disclosed provides for the uninterrupted communication between a receiver/transmitter disposed within a vehicle and a key fob no matter what interfering signals may be present.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of receiving signals with a remote actuation device comprising the steps of:
a) receiving a desired signal with a plurality of signal receiving devices disposed within a remote actuation device;
b) determining a direction of the desired signal; and
c) switching off at least one of the plurality of signal receiving devices that is not receiving signals in the direction of the desired signal.

2. The method as recited in claim 1, wherein the plurality of signal receiving devices comprises a plurality of antenna disposed to receive signals along a corresponding plurality of axes.

3. The method as recited in claim 2, including the step of measuring received signal strength for each of the plurality of signal receiving devices disposed to receive a signal on each of a plurality of corresponding axes independent of each other.

4. The method as recited in claim 3, including the step of determining a direction of an unwanted signal responsive to measured signal strength greater in one direction as compared to at least on other direction.

5. The method as recited in claim 2, wherein the plurality of signal receiving devices comprises a plurality of coils including at least one coil disposed to receive signals along a first, second and third axis, wherein each of the first, second and third axes are transverse relative to each other.

6. The method as recited in claim 4, wherein the step of switching off at least one of the plurality of signal receiving devices is further defined by switching off the signal receiving device disposed for receiving a signal in the direction indicated to have the greatest signal strength in a direction other than the direction of the desired signal.

7. The method as recited in claim 1, including the step of summing the signal received from each of the plurality of signal receiving devices that remain switched on.

8. A remote keyless entry system comprising:
a transmitter mountable within a vehicle for controlling at least one vehicle function;
a remote actuation device including a plurality of signal receiving devices and a controller; wherein the controller selectively switches off at least one of the plurality of signal receiving devices responsive to a received signal strength.

9. The system as recited in claim 8, wherein the plurality of signal receiving devices comprises at least one signal receiving device disposed to receive signals from one of a first, second and third axis, where each of the first, second and third axis are disposed transverse relative to each other.

10. The system as recited in claim 8, including a received signal strength indicator for measuring a signal strength received on each of the plurality of signal receiving devices.

11. The system as recited in claim 8, wherein the controller is programmed with instructions to disregard signals from one of the plurality of signal receiving devices with a received signal strength greater than any other measured signal strength in a direction other than a direction of a desired signal.

12. The system as recited in claim 11, wherein the controller is programmed to sum, demodulate and decode remaining signals.

13. The system as recited in claim 8, wherein the plurality of signal receiving devices comprises three coils disposed to receive signals in a direction of an incoming signal.

14. The system as recited in claim 8, wherein the remote actuation device comprises a key fob.

15. The system as recited in claim 8, wherein the desired signal comprise a low frequency signal with a modulation of 125 kHz.
